(19) United States
(12) Patent Application Publication
(10) Pub. No.: US 2008/0158511 A1
(43) Pub. Date: Jul. 3, 2008

(54) IMAGE PROJECTING APPARATUS

(75) Inventors: Hiromitsu TAKENAKA, Yokohama (JP); Katsutoshi SASAKI, Yokohama (JP); Mitsuhiro TOGASHI, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/859,275

(22) Filed: Sep. 21, 2007

(30) Foreign Application Priority Data
Dec. 28, 2006 (JP) 2006-356424
Mar. 14, 2007 (KR) 10-2007-0025141

(51) Int. Cl. G03B 21/28

(52) U.S. Cl. 353/20

(57) ABSTRACT

Provided is an image projecting apparatus, including: a polarization separator having a polarization separation surface which transmits or reflects illumination light and reflection light reflected from a reflective image display unit according to polarization directions of the illumination light and the reflection light; and a polarization direction rotating member, disposed between the polarization separator and the reflective image display unit, which rotates a polarization direction of light passing twice through the polarization direction rotating member by 90° about an optical axis of the polarization separator. The polarization separator and the polarization direction rotating member are disposed such that an axis bisecting an angle between a principal ray of the illumination light passing from the polarization separation surface to the reflective image display unit and a principal ray of the reflection light reflected from the reflective image display unit is approximately consistent with the optical axis of the polarization separator.

### CROSS-REFERENCE TO RELATED PATENT APPLICATION

This application claims priority from Japanese Patent Application No. 10-2006-356424, filed on Dec. 28, 2006, in the Japanese Intellectual Property Office, and the Korean Patent Application No. 10-2007-0025141, filed on Mar. 14, 2007, in the Korean Intellectual Property Office, the disclosures of which are incorporated herein in their entirety by reference.

### BACKGROUND OF THE INVENTION

1. Field of the Invention

Apparatuses consistent with the present invention relate to an image projecting apparatus.

2. Description of the Related Art

In a conventional image projecting apparatus using a reflective image display unit such as a digital micro mirror device (DMD), a light source unit having a large f-number should emit illumination light onto the reflection image display unit at a small angle. For this reason, an optical path separation unit is disposed near the reflective image display unit to separate the optical path of the illumination light from the optical path of light reflected from the reflective image display unit.

A projection optical system and a projector apparatus (image projecting apparatus) are disclosed in Japanese Patent Laid-Open Publication No. 2004-101826. The disclosed projection optical system includes a polarization separation prism as an optical path separation unit, and a polarization rotator. The polarization separation prism has a polarization separation surface for separating a light flux incident onto a DMD from a light flux departing from the DMD, and the polarization direction rotating member is disposed between the polarization separation surface of the polarization separation prism and the DMD to rotate the polarization direction of light passing therethrough.

However, the disclosed projection optical system and image projecting apparatus have the following problems.

Since the polarization separation prism is used as an optical path separation unit, most of S-polarized light to a reference incident plane of the polarization separation surface of the prism is transmitted through (or reflected from) the polarization separation surface, and most of P-polarized light to the reference incident plane is reflected from (or transmitted through) the polarization separation surface. For example, the plane of light incident to a dielectric multi-layer of the polarization separation prism can be the reference incident plane.

However, when light is incident onto the polarization separation prism in a plane crossing the reference incident plane, light separation characteristics of the polarization separation prism deteriorate since both p-polarization and s-polarization components are included in the light.

Furthermore, when light is incident onto the polarization separation prism in a plane crossing the reference incident plane, the polarization direction of the light is rotated about an optical axis of the polarization separation prism after the light is reflected from the polarization separation surface. Thereafter, the polarization direction of the light is further rotated by 90° about the optical axis after the light is reflected from the DMD and passes through the polarization rotator.

Therefore, when light is incident onto and reflected from the DMD in the same direction, an optical loss does not occur since light reflected from the polarization separation surface is rotated by 90° about the optical axis by the DMD and the polarization direction rotating member and then is incident back to the polarization separation surface. However, when light is incident onto the DMD at an incident angle other than 0°, the light is reflected from the DMD back to the polarization separation surface with the polarization direction of the light being changed to an undesirable direction. Thus, the light cannot be efficiently transmitted through the polarization separation surface of the polarization separation prism, resulting in optical losses.

That is, in the disclosed projection optical system and image projecting apparatus, although optical path separation can be efficiently performed at the polarization separation surface of the polarization separation prism in a plane containing a principal ray of illumination light and an optical axis of the illumination light and projection light, optical path separation cannot be efficiently performed in other planes. That is, optical losses occur when light is incident onto and transmitted through the polarization separation surface of the polarization separation prism in other planes.

### SUMMARY OF THE INVENTION

The present invention provides an image projecting apparatus that reduces optical loss at a polarization separator.

According to an aspect of the present invention, there is provided an image projecting apparatus for spatially modulating linearly polarized illumination light using a reflective image display unit to project the modulated light as reflection light indicating an image, the image projecting apparatus including: a polarization separator having a polarization separation surface which transmits or reflects the illumination light and the reflection light reflected from a reflection surface of the reflective image display unit according to polarization directions of the illumination light and the reflection light; and a polarization direction rotating member, disposed between the polarization separator and the reflective image display unit, which rotates a polarization direction of light passing twice through the polarization direction rotating member by 90° about an optical axis of the polarization separator, wherein the polarization separator and the polarization direction rotating member are disposed such that an axis bisecting an angle between a principal ray of the illumination light passing through the polarization separation surface and incident onto the reflection surface of the reflective image display unit and a principal ray of the reflection light reflected from the reflection surface of the reflective image display unit is approximately consistent with the optical axis of the polarization separator.

According to the present invention, linearly polarized illumination light is incident onto the polarization separator with the polarization direction of the illumination light being aligned with a polarization separation direction of the polarization separator. The illumination light is transmitted through or reflected from the polarization separator toward the reflection surface of the reflective image display unit through the polarization rotator. When the illumination light is reflected from the reflection surface of the reflective image display unit back to the polarization separator through the polarization rotator, the polarization direction of the illumination light is rotated by 90°. Therefore, the illumination light can be efficiently separated by the polarization separator. The optical axis of the polarization separator is approximately consistent with an axis bisecting an angle between a principal ray of the illumination light passing through the polarization separation surface and incident onto the reflection surface of the reflective image display unit and a principal ray of the reflection light reflected from the reflection surface of the reflective image display unit. Therefore, the polarization direction of illumination light incident onto the polarization separator at an angle can be approximately symmetric with the polarization direction of reflection light incident back to the polarization separator, so that undesired influence of a change in polarization direction can be reduced or eliminated using the polarization separator, thereby reducing optical loss.

### BRIEF DESCRIPTION OF THE DRAWINGS

The above and other exemplary aspects and advantages of the present invention will become more apparent by the following detailed description of exemplary embodiments thereof with reference to the attached drawings in which:

FIGS. 1A and 1B are a schematic front view illustrating an image projecting apparatus and a sectional view taken along line A-A of FIG. 1A according to exemplary embodiments of the present invention;

FIG. 2 is a schematic perspective view illustrating a polarization separator of the image projecting apparatus of FIG. 1A, according to an exemplary embodiment of the present invention;

FIGS. 3A and 3B are perspective views illustrating a related art polarization separator;

FIGS. 4A and 4B illustrate an operation of a quarter wave plate changing the polarization direction of light and a combinational operation of the quarter wave plate and a polarization direction rotating member according to exemplary embodiments of the present invention;

FIG. 5 is a schematic perspective view illustrating a polarization separator of the image projecting apparatus of FIG. 1A, according to another exemplary embodiment of the present invention;

FIG. 6A is a schematic front view illustrating an image projecting apparatus according to another exemplary embodiment of the present invention, and FIG. 6B is a sectional view taken along line B-B of FIG. 6A according to an exemplary embodiment of the present invention;

FIG. 7 is a schematic perspective view illustrating a polarization separator of the image projecting apparatus of FIG. 6A, according to an exemplary embodiment of the present invention;

FIG. 8 illustrates a quarter wave plate changing the polarization direction of light according to another exemplary embodiment of the present invention;

FIG. 9A is a schematic front view illustrating an image projecting apparatus according to another exemplary embodiment of the present invention, and FIGS. 9B and 9C are sectional views taken along lines C-C and D-D of FIG. 9A, according to exemplary embodiments of the present invention;

FIG. 10 is a schematic perspective view illustrating a polarization separator of the image projecting apparatus of FIG. 9A, according to an exemplary embodiment of the present invention;

FIG. 11A is a schematic side view illustrating a polarization separator of the image projecting apparatus of FIG. 9A, according to another exemplary embodiment of the present invention, and FIG. 11B is a schematic side view illustrating the polarization separator of FIG. 10 for comparing it with polarization separator of FIG. 11A;

FIG. 12 is a schematic graph illustrating the efficiency of the polarization separator of FIG. 11A;

FIG. 13 is a schematic side view illustrating another optical path of the polarization separator of FIG. 11A; and

FIG. 14 is a schematic graph illustrating the efficiency of the polarization separator of FIG. 13.

### DETAILED DESCRIPTION OF EXEMPLARY EMBODIMENTS OF THE INVENTION

The present invention will now be described more fully with reference to the accompanying drawings, in which exemplary embodiments of the invention are shown. Like reference numerals in the drawings denote like elements, and thus their description will be omitted.

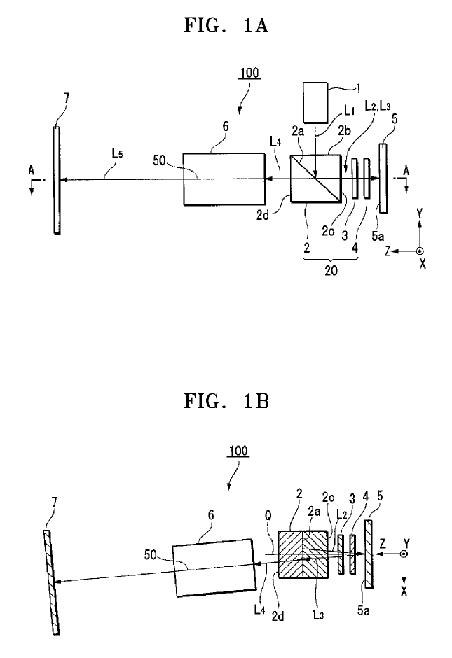

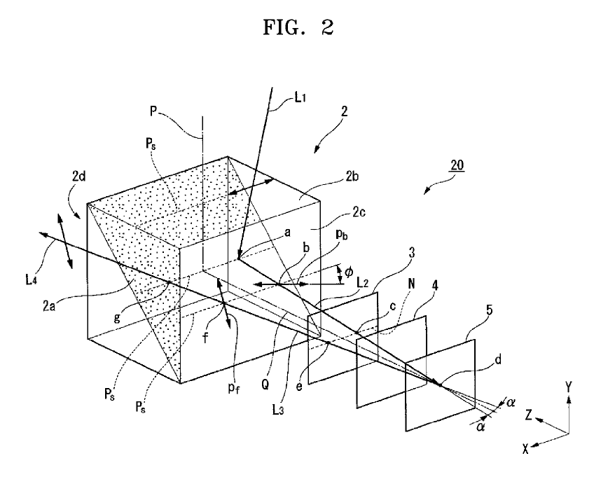

FIG. 1A is a schematic front view illustrating an image projecting apparatus 100 according to an embodiment of the present invention, and FIG. 1B is a sectional view taken along line A-A of FIG. 1A, according to an embodiment of the present invention. FIG. 2 is a schematic perspective view illustrating a polarization separator of the image projecting apparatus 100 of FIG. 1A, according to an embodiment of the present invention.

In the drawings, an XYZ Cartesian coordinate system is used to denote relative directions.

In FIG. 1A, the Z axis extends horizontally from right to left, the Y axis extends orthogonally upward to the Z axis, and the X axis extends forward in a direction perpendicular to the plane of the paper. The plane of FIG. 1A is the YZ plane.

The image projecting apparatus 100 of the current embodiment may be used for a video projector or a projection television, for example.

Referring to FIGS. 1A and 1B, the image projecting apparatus 100 includes a light source unit 1, a polarization splitter 2, a quarter wave plate 3, a polarization direction rotating member 4, a reflective image display unit 5, and an optical projection unit 6.

A projection image light from the image projecting apparatus 100 is projected on a screen 7. The screen 7 may be a transmissive screen or a reflective screen. When the screen 7 is a transmissive screen, the screen 7 can be fixed to a case (not shown) of the image projecting apparatus 100 to form a rear projection type image projecting system.

The light source unit 1 emits a linearly polarized uniform light flux having a wavelength λ as illumination light.

The light source unit 1 is positioned such that a principal ray L1 of a light flux emitted from the light source unit 1 is incident on the polarization splitter 2 along a path parallel with the XY plane and sloped down from right to left in the XY plane as shown in FIGS. 1A and 2. The polarization direction of the ray L1 is perpendicular to the optical axis and parallel with the XY plane as indicated by an arrow in FIG. 2. The ray L1 makes an angle with the Y axis, and the angle can be appropriately adjusted if necessary. For example, the ray L1 can make an angle of 15° or less with the Y axis to reduce an incident angle to a reflection surface of the reflective image display unit 5.

The polarization splitter 2 is a polarization separation prism including a polarization separation surface 2a formed by a dielectric multi-layer. When light is incident onto the polarization separation surface 2a in a negative Y-axis direction along a P axis parallel with the Y axis, about 100% of an s-polarization component of the light is reflected from the polarization separation surface 2a along a Q axis parallel with the Z axis in the negative direction of the Z axis, and about 100% of a p-polarization component of the light is transmitted through the polarization separation surface 2a. In the current embodiment, the polarization splitter 2 has a rectangular box shape.

The PQ plane is the plane of incidence (hereinafter, referred to as a reference incident plane) in which light is separated by reflection and transmission at the polarization separation surface 2a. That is, when the polarization separation surface 2a is formed of a dielectric multi-layer and light is incident onto the polarization separation surface 2a, the polarization directions of s- and p-polarization components of the incident light with maximal light separation efficiency is defined in the reference incident plane. In other words, when a light beam is incident onto the polarization separation surface 2a at a constant incident angle, the light beam can be separated more efficiently when the light beam is parallel with the reference incident plane than when the light beam is parallel with a plane crossing the reference incident plane.

The polarization splitter 2 further includes a first prism surface 2b between the polarization separation surface 2a and the light source unit 1. Illumination light emitted from the light source unit 1 enters the polarization splitter 2 through the first prism surface 2b. In the current embodiment, the first prism surface 2b is parallel with the ZX plane.

The polarization splitter 2 further includes a second prism surface 2c between the polarization separation surface 2a and the quarter wave plate 3. Light reflected from the polarization separation surface 2a exits the polarization splitter 2 through the second prism surface 2c. In the current embodiment, the second prism surface 2c is parallel with the XY plane.

The polarization splitter 2 further includes a third prism surface 2d parallel with the second prism surface 2c, and the third prism surface 2d faces the second prism surface 2c across the polarization separation surface 2a. Light transmitted through the polarization separation surface 2a in the positive direction of the Z axis is directed to the optical projection unit 6 through the third prism surface 2d.

In FIG. 2, dashed lines Ps drawn on the first prism surface 2b and the second prism surface 2c indicate the polarization direction of the s-polarization component of light incident onto the polarization separation surface 2a in the reference incident plane.

Although the polarization splitter 2 has a rectangular box shape in the current embodiment, the polarization splitter 2 can have other shapes. For example, the first prism surface 2b, the second prism surface 2c, and the third prism surface 2d of the polarization splitter 2 can be inclined with respect to each other.

In the following description, refractions at the first prism surface 2b, the second prism surface 2c, and the third prism surface 2d will be neglected for brevity of the description.

The quarter wave plate 3 is a ¼ wave plate designed according to the wavelength λ of illumination light emitted from the light source unit 1. The quarter wave plate 3 has a main axis (N) parallel with the polarization direction of S-polarized light incident onto the polarization separation surface 2a. The quarter wave plate 3 is spaced apart from the second prism surface 2c in the negative direction of the Z axis and is approximately parallel with the XY plane.

The polarization direction rotating member 4 rotates the polarization direction of light reciprocating through the polarization direction rotating member 4 by 90° about the optical axis of the polarization direction rotating member 4. The polarization direction rotating member 4 is spaced apart from the quarter wave plate 3 in the negative z-axis direction and is approximately parallel with the quarter wave plate 3. The optical axis of the polarization direction rotating member 4 is parallel with the Q axis. For example, a line optical rotator using liquid crystal can be used as the polarization direction rotating member 4.

The reflective image display unit 5 includes a display surface 5a on which a plurality of display elements is arranged in a two-dimensional grating pattern. The reflective image display unit 5 is a spatial light modulator which modulates illumination light by controlling the reflection directions of the display elements according to image pixels. In the current embodiment, a digital micro mirror device (DMD) is used as the display elements. In the DMD, micro mirrors (not shown) are arranged in a two-dimensional grating pattern, and each micro mirror can be moved to two differently inclined positions in on- and off-states, respectively, according to an image signal.

In the current embodiment, the micro mirror can be aligned in parallel with the XY plane in the on-state. Further, the micro mirror can be inclined from the XY plane in the off-state to prevent illumination light reflected from the micro mirror from being incident onto the optical projection unit 6.

In the on-state, a line normal to a reflection surface of the micro mirror is parallel with the reference incident plane on the polarization separation surface 2a. Therefore, when a ray is reflected from the micro mirror of the reflective image display unit 5 in an on-state, the reflected ray is symmetric with the incident light beam with respect to a plane parallel with the reference incident plane of the polarization separation surface 2a.

In the current embodiment, the reflection surfaces of the micro mirrors are positioned on the same plane as the display surface 5a of the reflective image display unit 5 in an on-state. However, the reflection surfaces of the micro mirrors can be inclined from the display surface 5a of the reflective image display unit 5 in the on-state. What is important in this case is the relationship between the normal line of the reflection surfaces of the micro mirrors and the reference incident plane.

The optical projection unit 6 is an optical device or a group of optical devices. Illumination light is reflected from the micro mirrors of the reflective image display unit 5 in an on-state and is transmitted to the optical projection unit 6 through the polarization direction rotating member 4, the quarter wave plate 3, and the polarization splitter 2 to form an image. Then, the optical projection unit 6 projects the image onto the screen 7 on an enlarged scale.

Referring to FIG. 1B, an optical axis 50 of the optical projection unit 6 is inclined from −X axis to +Z axis in the ZX plane in correspondence with a light beam reflected from the micro mirror of the reflective image display unit 5 aligned in parallel with the XY plane.

In the current embodiment, the polarization splitter 2, the quarter wave plate 3, and the polarization direction rotating member 4 are included in a polarization separator 20. The polarization separator 20 is disposed between the light source unit 1 and the reflective image display unit 5 in order to divide light emitted from the light source unit 1 according to the polarization of the light, and between the reflective image display unit 5 and the optical projection unit 6 in order to divide light reflected from the reflective image display unit 5 according to the polarization of the light.

An operation of the image projecting apparatus 100 will now be described. In the following description, an operation of the polarization separator 20 of the image projecting apparatus 100 is mainly explained, and each ray is a principal ray of the optical system constituting the image projecting apparatus 100 unless it is mentioned otherwise.

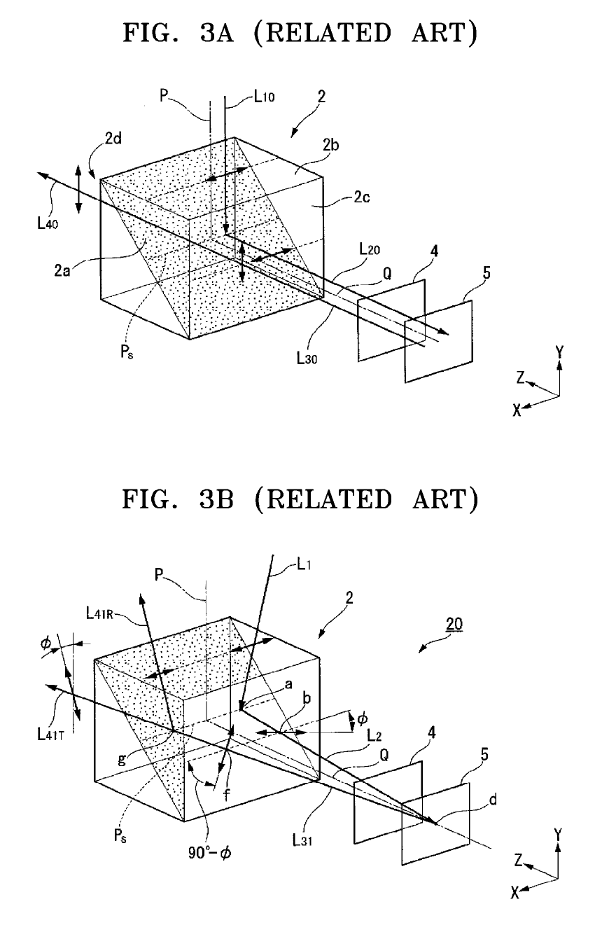

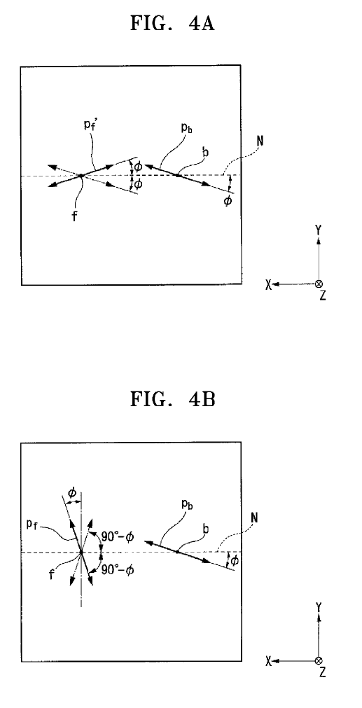

FIGS. 3A and 3B are perspective views illustrating a related art polarization separator as a comparison example. FIG. 4A illustrates an operation of the quarter wave plate 3 changing the polarization direction of light according to an embodiment of the present invention, and FIG. 4B illustrates a combinational operation of the quarter wave plate 3 and the polarization direction rotating member 4 according to an embodiment of the present invention.

Referring again to FIG. 2, a ray L1 emitted from the light source unit 1 is polarized in a direction perpendicular to the optical axis of the light source unit 1 and parallel with the XY plane. The ray L1 is incident onto a point (a) of the polarization separation surface 2a through the first prism surface 2b at a small angle with the P axis in the XY plane. Since the ray L1 is S-polarized at the point (a) of the polarization separation surface 2a, 100% of the lay L1 is reflected from the polarization separation surface 2a toward the quarter wave plate 3 through a point (b) of the second prism surface 2c. After the reflection, the ray L1 is denoted as a ray L2.

Since a plane of incidence defined by the rays L1 and L2 on the polarization separation surface 2a is slightly inclined from the reference incident plane (the PQ plane), the polarization direction of the ray L2 makes an angle with the s-polarization direction. For example, the polarization direction of the ray L2 makes an angle Φ with the s-polarization direction in a clockwise direction.

Although the angle Φ is not exactly equal to a rotation angle of the polarization direction of the ray L2 measured about the optical axis since the polarization direction of the ray L2 is rotated by the angle Φ on the XY plane, the difference can be neglected in the current embodiment since the ray L2 is inclined from the Q axis very little.

The ray L2 proceeds toward the quarter wave plate 3 in the ZX plane at a small angle α with the Q axis. The ray L2 is incident onto the reflective image display unit 5 through the quarter wave plate 3 and the polarization direction rotating member 4. The display surface 5a of the reflective image display unit 5 is illuminated by the ray L2 and other rays.

If the ray L2 is incident at a point (d) of a micro mirror of the reflective image display unit 5 that is in an on state, the ray L2 is incident at an incident angle α and reflected at a reflection angle α in the ZX plane. After the ray L2 is reflected from the point (d), the ray L2 is denoted as a ray L3. The ray L3 proceeds to a point (f) of the second prism surface 2c through the polarization direction rotating member 4 and the quarter wave plate 3 at the reflection angle α from the Q axis in the ZX plane.

That is, the ray L3 arrived at the point (f) has passed through the quarter wave plate 3 and the polarization direction rotating member 4 two times.

Operations of the quarter wave plate 3 and the polarization direction rotating member 4 will now be described.

First, variations in polarization direction will be described with reference to FIGS. 3A and 3B, in which a conventional polarization separator not including a quarter wave plate is illustrated. In FIG. 3A, rays are drawn beside actual optical axes P and Q for clarity.

Referring to FIG. 3A, a ray L10 is incident onto a polarization splitter 2 along the P axis. The polarization direction of the ray L10 is perpendicular to a reference incidence plane (the PQ plane). That is, the ray L10 is S-polarized. About 100% of the ray L10 is reflected from a polarization separation surface 2a. After the reflection, the ray L10 is denoted as a ray L20. The ray L20 exits the polarization splitter 2 through a second prism surface 2c. Next, the ray L20 passes through a polarization direction rotating member 4 without a change in polarization direction. Next, the ray L20 is reflected from a reflective image display unit 5. After the reflection, the ray L20 is denoted as a ray L30. The ray L30 passes through the polarization direction rotating member 4 again and is incident on the second prism surface 2c again.

The polarization direction of the ray L30 is rotated 90° from that of the ray L20 about the Q axis since the ray has passed through the polarization direction rotating member 4 back and forth. That is, the polarization direction of the ray L30 is perpendicular to that of the ray L20 reflected from the polarization separation surface 2a. Therefore, about 100% of the ray L30 is transmitted through the polarization separation surface 2a. After the transmission, the ray L30 is denoted as a L40. The ray L40 exits the polarization splitter 2 through a third prism surface 2d.

Therefore, optical paths of the rays L10 and L40 can be separated with almost no optical loss.

Referring to FIG. 3B, all structures and conditions are the same as those shown in FIG. 2 except that the quarter wave plate 3 is not included in FIG. 3B. In this case, the polarization direction of a ray L2 makes an angle Φ with the s-polarization direction perpendicular to the reference incidence plane on the polarization separation surface 2a. Therefore, when the ray L2 is incident onto a point (f) of the second prism surface 2c as a ray L31 via the polarization direction rotating member 4, the reflective image display unit 5, and the polarization direction rotating member 4, the polarization direction of the ray L31 is rotated from that of the ray L20 by 90°. That is, the polarization direction of the ray L31 makes an angle of (90°-Φ) with the s-polarization direction. Further, the polarization direction of the ray L31 is rotated clockwise from an axis perpendicular to the s-polarization direction by an angle Φ when viewed from the negative Z axis.

Referring again to FIG. 2, since the rays L2 and L3 are symmetric with respect to the reference incident plane (the PQ plane) to the polarization separation surface 2a, polarization directions of the rays L2 and L3 resulting in the rays L2 and L3 being most effectively reflected from the polarization separation surface 2a are symmetric with respect to the reference incident plane. Further, polarization directions of the rays L2 and L3 resulting in the rays L2 and L3 being most effectively transmitted through the polarization separation surface 2a are symmetric with the reference incident plane. Therefore, when light is polarized at the point (f) in a direction rotated counterclockwise by an angle Φ from the s-polarization direction perpendicular to the reference incident plane (viewed from the negative Z axis), about 100% of the light is reflected at the point (g) of the polarization separation surface 2a. Further, when light is polarized at the point (f) in a direction rotated counterclockwise by an angle Φ from a direction (Y-axis direction) perpendicular to the s-polarization direction (viewed from the negative Z axis), about 100% of the light passes through the point (g) of the polarization separation surface 2a.

Referring again to FIG. 3B, when viewed from the negative Z axis, the polarization direction of the ray L31 at the point (f) is rotated clockwise by an angle 2Φ from a polarization direction which has the polarization separation of the ray L31 at the point (g) of the polarization separation surface 2a be about 100%. Therefore, at the point (g), the ray L31 is split into a transmitted ray L41T and a reflected ray L41R. The reflected ray L41R does not reach the optical projection unit 6, thereby resulting in an optical loss.

However, in the present invention, the quarter wave plate 3 having a main axis parallel with the s-polarization direction is disposed between the polarization splitter 2 and the polarization direction rotating member 4 for the rays L2 and L3. Therefore, the polarization direction of the ray L3 can adjusted to a desired direction such that the ray L3 can be most effectively transmitted through the polarization separation surface 2a.

The quarter wave plate 3 converts linearly polarized light into elliptically polarized light or circularly polarized light according to the angle between the linearly polarized light and a main axis (N) of the quarter wave plate 3, and vice versa. The quarter wave plate 3 can be equivalent to a half wave plate when light passes through the quarter wave plate 3 back and forth. That is, when the polarization direction rotating member 4 is not included in the current embodiment, a polarization direction pf′ of the ray L3 at the point (f) is symmetric to a polarization direction pb of the ray L2 at the point (b) with respect to the main axis (N) as shown in FIG. 4A. In other words, when viewed from the negative Z axis, the polarization direction of the ray L2 is rotated counterclockwise by an angle Φ when the ray L2 passes through the quarter wave plate 3 one time. Further, since the main axis (N) of the quarter wave plate 3 is parallel with a normal line of the reference incident plane, the polarization direction of linearly polarized light may be symmetrical to the polarization direction of the linearly polarized light with respect to the reference incident plane after the linearly polarized light passes through the quarter wave plate 3 back and forth.

In the current embodiment, the polarization direction rotating member 4 is disposed between the quarter wave plate 3 and the reflective image display unit 5. In this case, because a ray traveling among the quarter wave plate 3, the polarization direction rotating member 4, and the reflective image display unit 5 is not a linearly polarized ray, a conceptual description can be made as follows. When the ray L2 passes through the quarter wave plate 3 and polarization direction rotating member 4 back and forth, the polarization direction pb of the ray L2 at the point (b) is rotated by 90° about the optical axis of the polarization separator 20 by the polarization direction rotating member 4 and is symmetrically transformed with respect to the main axis (N) as shown in FIG. 4B. That is, the polarization direction of the ray L3 at the point (f) is rotated counterclockwise by an angle Φ from the Y axis when viewed from the negative Z axis.

In other words, the quarter wave plate 3 and the polarization direction rotating member 4 form a polarization compensation unit that compensates for the polarization direction of light separated at the polarization separation surface 2a and directed to the reflective image display unit 5 by a combinational transformation including a symmetric transformation with respect to the reference incident plane and a 90-degree rotation transformation about the optical axis of the polarization separator 20.

Therefore, in the embodiment of FIG. 2, the polarization direction of the ray L3 is adjusted such that about 100% the ray L3 can pass through the point (g) of the polarization separation surface 2a and exit the polarization splitter 2 through the third prism surface 2d. After the ray L3 passes through the point (g) of the polarization separation surface 2a, the ray L3 is denoted as a ray L4.

Furthermore, as shown in FIG. 1, the ray L4 proceeds along the optical axis 50 of the optical projection unit 6 and reaches the screen 7.

As explained above, in the image projecting apparatus 100 of the present invention, although illumination light is incident onto the polarization splitter 2 in a plane crossing the reference incident plane of the polarization splitter 2, a principal ray of the illumination light can be split by the polarization splitter 2 according to the polarization of the principal ray without an optical loss. Therefore, for example, optical losses can be reduced as compared with the case of FIG. 3B in which the quarter wave plate 3 is not disposed between the polarization splitter 2 and the polarization direction rotating member 4,

Further, this advantage of reducing optical loss is achieved by properly positioning the reflective image display unit 5. That is, the reflective image display unit 5 is positioned such that a normal line to the reflection surface of the reflective image display unit 5 is parallel with the reference incident plane of the polarization splitter 2, and thus the polarization direction of the principal ray along an optical path is symmetric with respect to the reference incident plane.

When the reflective image display unit 5 is not positioned as described above, optical loss can increase according to the asymmetric degree of the polarization direction of the principal ray along the optical path. However, the normal line to the reflection surface of the reflective image display unit 5 can be slightly inclined from the reference incident plane of the polarization splitter 2 as long as the increase in optical loss is within an allowable range.

Although the function of the quarter wave plate 3 is described with respect to the principal ray of illumination light in the above description, the quarter wave plate 3 can compensate for the polarization direction of other illumination light that is incident onto the polarization splitter 2 in a plane crossing the reference incident plane so as to reduce optical losses.

Furthermore, in the above-described embodiments, the plane of incidence of the reflective image display unit 5 is parallel with the ZX plane and perpendicular to the reference incident plane. However, when the plane of incidence of the reflective image display unit 5 is rotated by a predetermined angle about a normal line to the reflection surface of the micro mirror of the reflective image display unit 5 (for example, when the point (a) on the polarization separation surface 2a in FIG. 3B is deviated in the positive Y-axis direction, and the point (g) is deviated in the negative Y-axis direction), the polarization direction of a ray is not rotated symmetrically with respect to the reference incident plane. Thus, the polarization direction of the ray is not perfectly compensated for. However, even in this case, the rotation of the polarization direction can be reduced by the polarization compensation unit, and thus optical loss can be reduced as compared with the case where the polarization compensation unit is not used.

A modified version of the polarization separator will now be described.

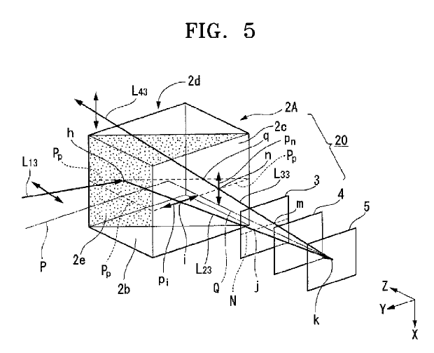

FIG. 5 is a schematic perspective view illustrating a modified version of the polarization separator of the image projecting apparatus 100 depicted in FIG. 1A according to another embodiment of the present invention.

Instead of the polarization splitter 2, a polarization splitter 2A is used in the current embodiment. The polarization splitter 2A has a polarization separation surface 2e from which P-polarized light is reflected. P-polarized light means light polarized in a reference incident plane (a PQ plane). For this, illumination light is P-polarized in the reference incident plane. Therefore, a main axis (N) of a quarter wave plate 3 is adjusted parallel to the Y-axis direction in consideration of the polarization direction of light reflected from the polarization separation surface 2e toward a reflective image display unit 5.

In FIG. 5, a dashed line Pp indicates the p-polarization direction of light in the reference incident plane such that the polarization direction of light reflected from the polarization separation surface 2e toward the reflective image display unit 5 can be easily understood. The dashed line Pp drawn on a second prism surface 2c of the polarization splitter 2A is parallel with the main axis (N) of the quarter wave plate 3.

In the current embodiment, a principal ray L13 of illumination light emitted from the light source unit 1 is incident onto a first prism surface 2b of the polarization splitter 2A along a path parallel with the YZ plane and inclined from a P axis toward the positive Z axis. The ray L13 reaches a point (h) of the polarization separation surface 2e.

Since the ray L13 is P-polarized, about 100% of the ray L13 is reflected from the polarization separation surface 2e. After the reflection, the ray L13 is denoted as a ray L23. The ray L23 exits the polarization splitter 2A through a point (i) of the second prism surface 2c. Then, the ray L23 reaches the reflective image display unit 5 through the quarter wave plate 3 and a polarization direction rotating member 4. Thereafter, the ray L23 is reflected by a micro mirror of the reflective image display unit 5. After the reflection, the ray L23 is denoted as a ray L33. The ray L33 passes through the polarization direction rotating member 4 and the quarter wave plate 3 again and then reaches a point (n) of the second prism surface 2c.

Since the polarization direction of the ray L23 at the point (i) is parallel with the Y axis and the main axis (N) of the quarter wave plate 3, the polarization direction of the ray L23 is rotated by 90° about an optical axis by only the polarization direction rotating member 4. Therefore, the polarization direction of the ray L33 at the point (n) is parallel with the X axis.

As a result, about 100% of the ray L33 passes through a point (q) of the polarization separation surface 2e and exits the polarization splitter 2A through a third prism surface 2d. After the ray L33 passes through the point (q) of the polarization separation surface 2e, the ray L33 is denoted as a ray L43. Then, the ray L43 is incident onto the optical projection unit 6 along the optical axis 50 and then is projected onto the screen 7.

In present embodiment, the principal ray can be split according to polarization without an optical loss. Since the principal ray travels in the reference incident plane, the polarization direction of the principal ray is not changed by the quarter wave plate 3. However, other illumination light incident onto the polarization splitter 2A in a plane crossing the reference incident plane is rotated in polarization direction by the polarization splitter 2A like in the previous description. In this case, the polarization direction of the illumination light can be compensated for by the quarter wave plate 3 so that optical losses can be reduced. Therefore, when all illumination light is considered, the quarter wave plate 3 is useful to reduce optical loss.

An image projecting apparatus will now be described according to another embodiment of the present invention.

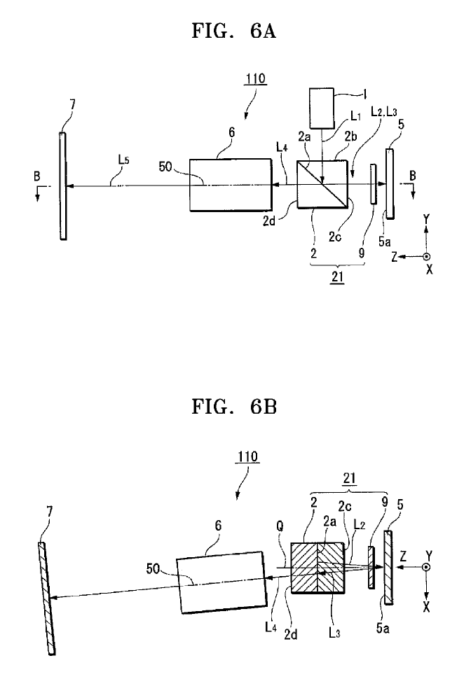

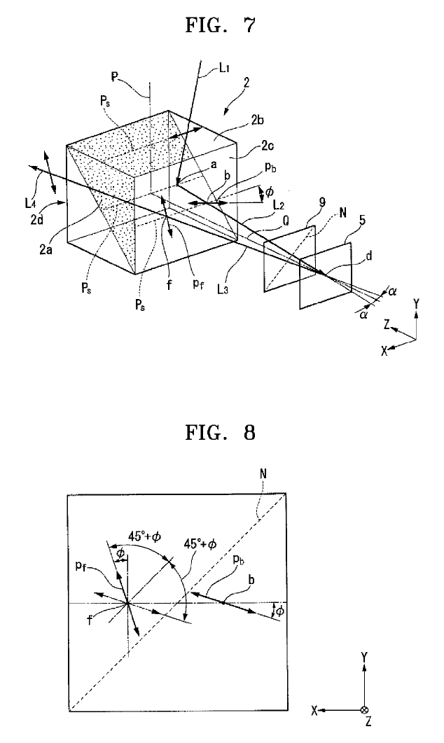

FIG. 6A is a schematic front view illustrating an image projecting apparatus 110 according to another embodiment of the present invention, and FIG. 6B is a sectional view taken along line B-B of FIG. 6A. FIG. 7 is a schematic perspective view illustrating a polarization separator 21 of the image projecting apparatus 110 of FIG. 6A, according to an embodiment of the present invention. FIG. 8 illustrates a quarter wave plate 9 for changing the polarization direction of light according to an embodiment of the present invention.

In the current embodiment, as shown in FIGS. 6A and 6B, the image projecting apparatus 110 includes a quarter wave plate 9, instead of the quarter wave plate 3 and the polarization direction rotating member 4 that are included in the image projecting apparatus 100 of FIG. 1A. A polarization splitter 2 and the quarter wave plate 9 form a polarization separator 21. In the following description, only the differences between the image projecting apparatus 110 and the image projecting apparatus 100 will be mainly mentioned.

The quarter wave plate 9 is a ¼ wave plate designed according to the wavelength λ of illumination light. Referring to FIG. 7, the quarter wave plate 9 has a main axis (N) making an angle of about 45° with the s-polarization direction perpendicular to a reference incident plane (a PQ plane). The quarter wave plate 9 is disposed away from a second prism surface 2c of the polarization splitter 2 in the negative z-axis direction and is approximately parallel with the XY plane.

In the current embodiment, the case where a ray passes through the quarter wave plate 9 back and forth is equivalent to the case where a ray passes through the quarter wave plate 3 and the polarization direction rotating member 4 back and forth in the embodiment illustrated in FIG. 2.

Referring to FIGS. 7 and 8, a polarization direction Pb of a ray L2 at a point (b) is changed to a polarization direction Pf of a ray L3 at a point (f) with respect to the main axis (N) of the quarter wave plate 9. That is, the polarization direction Pf of the ray L3 is rotated counterclockwise by an angle Φ from a direction perpendicular to the s-polarization direction of the reference incident plane when viewed from the negative Z axis. Therefore, about 100% of the ray L3 passes through a polarization separation surface 2a and is incident onto an optical projection unit 6 along an optical axis 50 like in the embodiment of FIG. 1A.

That is, the quarter wave plate 9 forms a polarization compensation unit that compensates for the polarization direction of light separated at the polarization separation surface 2a and directed to the reflective image display unit 5 by a transformation corresponding to a combinational transformation including a symmetric transformation with respect to the reference incident plane and a 90-degree rotation transformation about the optical axis of the polarization separator 21.

Further, the compensation operation of the quarter wave plate 9 is achieved by properly positioning the reflective image display unit 5. That is, the reflective image display unit 5 is positioned such that a normal line to the reflection surface of the reflective image display unit 5 is parallel with the reference incident plane of the polarization splitter 2, and thus the polarization direction of the principal ray along an optical path is symmetric with respect to the reference incident plane.

When the reflective image display unit 5 is not positioned as described above, the ray L3 is not most effectively separated at the polarization separation surface 2a like the case where a quarter wave plate is used to rotate the polarization direction of light by 90° about an optical axis by passing the light through the quarter wave plate back and forth. In other words, the ray L3, which is rotated by 90° about an optical axis and incident onto the polarization separation surface 2a at an angle, cannot have an optical polarization direction for efficient optical separation only by positioning the main axis (N) of the quarter wave plate 3 at an angle of 45° with the polarization direction of incident light.

However, the normal line to the reflection surface of the reflective image display unit 5 can be slightly included from the reference incident plane of the polarization splitter 2 as long as optical losses caused by the inclination are within an allowable range.

In the image projecting apparatus 110, optical loss can be reduced much more as compared with the case of FIG. 3B in which only the polarization direction rotating member 4 is disposed between the polarization splitter 2 and the reflective image display unit 5.

An image projecting apparatus will now be described according to another embodiment of the present invention.

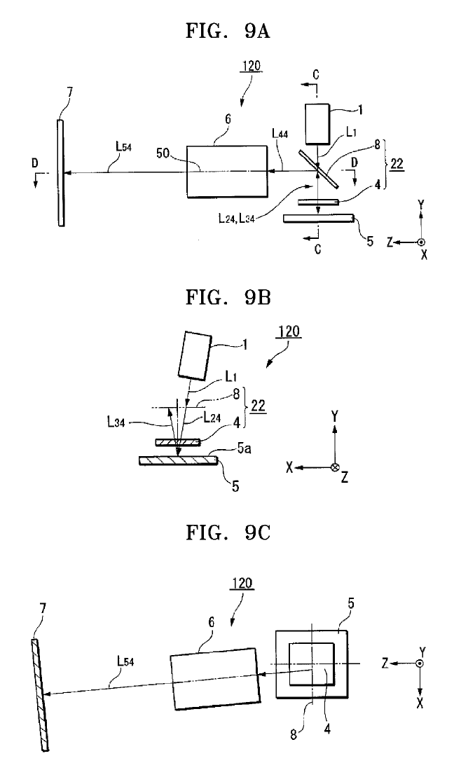

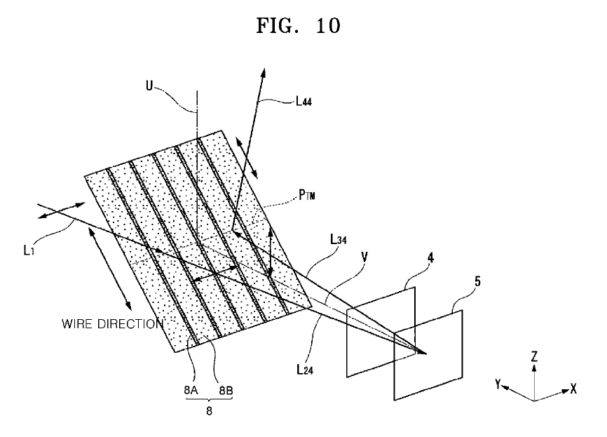

FIG. 9A is a schematic front view illustrating an image projecting apparatus 120 according to another embodiment of the present invention, and FIGS. 9B and 9C are sectional views taken along lines C-C and D-D of FIG. 9A. FIG. 10 is a schematic perspective view illustrating a polarization separator of the image projecting apparatus 120 of FIG. 9A, according to an embodiment of the present invention.

Referring to FIGS. 9A, 9B, and 9C, the image projecting apparatus 120 of the current embodiment includes a wire grid polarizer (WGP) 8 instead of the polarization splitter 2 of the image projecting apparatus 100 of FIG. 1A. The quarter wave plate 3 is not included in the image projecting apparatus 120. In the following description, only the differences between the image projecting apparatus 120 and the image projecting apparatus 100 will be mainly mentioned.

The image projecting apparatus 120 of the current embodiment includes a light source unit 1, an optical projection unit 6, and a screen 7 that are disposed in the same way as in the image projecting apparatus 100. However, since illumination light emitted from the light source unit 1 and passing through the WGP 8 is directed to a reflective image display unit 5, a polarization direction rotating member 4 and the reflective image display unit 5 are disposed parallel with the ZX plane.

Referring to FIG. 10, the WGP 8 includes a substrate 8B formed of an insulation material and a plurality of metal wires 8A formed on the substrate 8B in parallel with each other at a minute pitch. About 100% of light having an electric field vector perpendicular to the length direction of the metal wires 8A (transverse magnetic (TM) polarized light) is transmitted through the WGP 8, and about 100% of light having an electric field vector perpendicular to TM polarized light (transverse electric (TE) polarized light) is reflected from the WGP 8. The pitch of the metal wires 8A can be adjusted according to the wavelength λ of illumination light emitted from the light source unit 1 to increase the light separating efficiency of the WGP 8.

Hereinafter, an incident plane parallel with the length direction of the metal wires 8A and perpendicular to the substrate 8B will be referred to as a reference incident plane of the WGP 8.

In the current embodiment, the WGP 8 is perpendicular to the YZ plane and inclined from the ZX and XY planes, and a normal line (V) of a reflection surface of the reflective image display unit 5 is parallel with the reference incident plane. That is, after TE polarized light passing through the normal line (V) is reflected from the WGP 8, the TE polarized light proceeds along a U axis parallel with the Z axis.

In the current embodiment, the WGP 8 and the polarization direction rotating member 4 form a polarization separator 22. The polarization separator 22 is disposed among the light source unit 1, the reflective image display unit 5, and the optical projection unit 6 to separate an optical path of illumination light emitted from the light source unit 1 from an optical path of light reflected from the reflective image display unit 5 according to the polarization direction of the light.

Referring to FIG. 10, in the image projecting apparatus 120, a principal ray L1 of illumination light emitted from the light source unit 1 and polarized in the x-axis direction is directed to the WGP 8 along a path parallel to the XY plane and inclined downward from the reference incident plane of the WGP 8.

Since the ray L1 is TM polarized, about 100% of the ray L1 passes through the WGP 8. After the ray L1 passes through the WGP 8, the ray L1 is denoted as a ray L24. The ray L24 proceeds to the polarization direction rotating member 4. After passing through the WGP 8, the ray L24 does not change in polarization direction because the polarization direction of light passing through the WGP 8 is determined by the length direction of the metal wires 8A of the WGP 8, not by the angle between the reference incident plane and the plane of incidence of the light to the metal wires 8A.

The ray L24 passes through the polarization direction rotating member 4 and reaches a reflection surface of the reflective image display unit 5. When the reflective image display unit 5 is in an on state, the ray L24 is reflected from the reflection surface of the reflective image display unit 5 back to the polarization direction rotating member 4. Here, after the ray L24 is reflected from the reflection surface of the reflective image display unit 5, the ray L24 is denoted as a ray L34.

The polarization direction of the ray L34 is rotated by 90° about an optical axis after the ray L34 passes through the polarization direction rotating member 4, and then the ray L34 is incident back to the WGP 8 as TE polarized ray. Thus, about 100% of the TE polarized ray L34 is reflected from the WGP 8 and proceeds along an optical axis 50. After the ray L34 is reflected from the WGP 8, the ray L34 is denoted as a ray L44. The ray L44 is projected to the screen 7 through the optical projection unit 6. In this way, illumination light emitted from the light source unit 1 and reflected from the reflection surface of the reflective image display unit 5 can be projected to the screen 7 through the optical projection unit 6 without optical losses at the WGP 8.

According to the image projecting apparatus 120 of the current embodiment, although illumination light is incident onto the WGP 8 in a plane crossing the reference incident plane of the WGP 8, the principal ray of the illumination light can be split according to the polarization principal ray without optical losses at the WGP 8. Therefore, optical losses can be reduced as compared with, for example, the related art polarization separator of FIG. 3B configured with only the polarization splitter 2 and the polarization direction rotating member 4.

In the current embodiment, the WGP 8 is used instead of the polarization splitter 2 (refer to FIG. 2) using a dielectric multi-layer as the polarization separation surface 2a. In this case, the polarization direction of light reflected from the WGP 8 or passing through the WGP 8 is not affected by an angle between the reference incident plane of the WGP 8 and the plane of incidence of the light, or by an incident angle of the light like in the case of the polarization splitter 2. Therefore, the optical path of the image projecting apparatus 120 can be designed more freely.

For example, although it is explained that the normal line (V) to the reflection surface of the reflective image display unit 5 is parallel to the reference incident plane of the WGP 8 when the reflective image display unit 5 is in on state like in the embodiments of FIGS. 1A and 6A, this positional relationship between the reflective image display unit 5 and the WGP 8 is not definitely required in the current embodiment. If necessary, the reflective image display unit 5 and WGP 8 can be positioned in other manners.

A modified version of the polarization separator 22 will now be described.

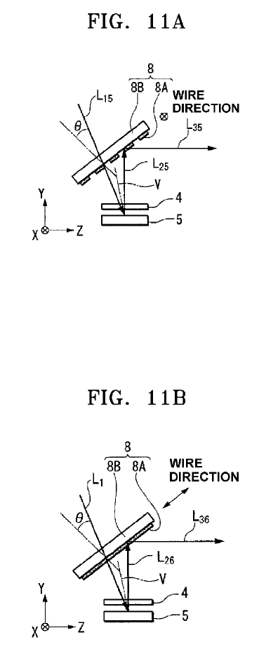

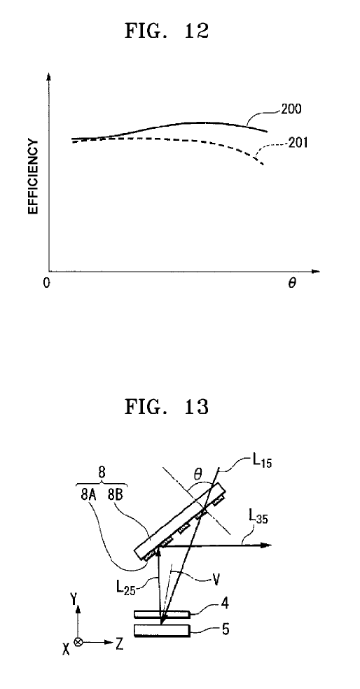

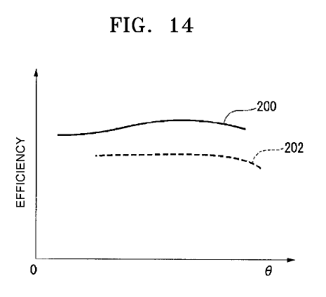

FIG. 11A is a schematic side view illustrating a polarization separator of the image projecting apparatus 120 of FIG. 9A as a modified version. FIG. 11B is a schematic side view illustrating the polarization separator of FIG. 10 for comparing it with polarization separator of FIG. 11A. FIG. 12 is a schematic graph illustrating the efficiency of the polarization separator of FIG. 11A. In FIG. 12, the horizontal axis denotes an incident angle θ to a WGP 8, and the vertical axis denotes light separating efficiency (the same in FIG. 14). FIG. 13 is a schematic side view illustrating another optical path of the polarization separator of FIG. 11A, and FIG. 14 is a schematic graph illustrating the efficiency of the polarization separator of FIG. 13.

Referring to FIG. 11A, metal wires 8A of a WGP 8 are rotated by 90° on a substrate 8B as compared with the metal wires 8A of the WGP 8 of FIG. 10. In the WGP 8 of FIG. 10, the metal wires 8A are parallel to the reference incident plane of the WGP 8 (the UV plane) that contains the normal line (V) of the reflection surface of the reflective image display unit 5 and bisects an angle between the plane of incidence of the ray L1 to the WGP 8 and the plane of incidence of the ray L34 to the WGP 8. In the WGP 8 of FIG. 11A, the metal wires 8A are parallel to a normal line to the reference incident plane of the WGP 8. When the plane of incidence of illumination light is equal to the plane of incidence of projection light, the metal wires 8A are parallel to a normal line to the plane of incidence of the illumination light and the projection light.

Therefore, the polarization direction of illumination light incident onto the WGP 8 is rotated 90° about an optical axis as compared with the case of the WGP 8 of FIG. 10. A ray L15 passes through a polarization direction rotating member 4 and then is reflected by a reflective image display unit 5. After that, the ray L15 is denoted as a ray L25. The polarization direction of the ray 25 makes an angle of 90° with the polarization direction of the ray L15. The ray L25 is incident onto the WGP 8 and reflected from the WGP 8 as a ray L35.

In this case, the WGP 8 of FIG. 11A can separate incident light according to the polarization direction of the light like the WGP 8 of FIG. 10. However, the polarization separation efficiency of the WGP 8 of FIG. 11A can be improved as compared with that of the WGP 8 of FIG. 10. The term “polarization separation efficiency” represents a ratio of a light output from the polarization separator that is used for image projection to a light input (illumination light) to the polarization separator.

When an incident angle of illumination light to the WGP 8 is θ, the relationship between the polarization separation efficiency of the WGP 8 and the incident angle θ is shown by a curve 200 in FIG. 12. While the incident angle θ increases from 0° to 70°, the curve 200 changes in a horizontal parabolic path (an almost linear path).

However, as shown in FIG. 11B, the arrangement of the metal wires 8A of the WGP 8 of FIG. 10 results in an efficiency-angle curve 201 shown in FIG. 12. Although the curve 201 is approximately horizontal when the incident angle θ ranges from 0° to 55°, the curve 201 moves downward when the incident angle θ is higher than 60° (i.e., the polarization separation efficiency decreases when the incident angle θ is higher than 60°). Therefore, when the incident angle θ is large, the arrangement of the metal wires 8A of the WGP 8 of FIG. 11A is advantageous.

The WGP 8 of FIG. 11A can have an optical path shown in FIG. 13, in which an optical path of a ray L15 (illumination light) between the WGP 8 and the reflective image display unit 5 crosses an optical path of a ray L35 reflected from the WGP 8.

Since the optical paths cross each other, the WGP 8 can be formed into a compact layout. However, as shown by a curve 202 of FIG. 14, when the optical paths of the rays L15 and L35 cross each other, the polarization separation efficiency of the WGP 8 can be decreased as compared with the case of FIG. 11A in which the optical paths of the rays L15 and L35 do not cross each other. That is, when the polarization separation efficiency of the WGP 8 is more important than the compact structure of the WGP 8, the optical paths of the L15 and L35 may be designed not to cross each other.

In the embodiments of FIGS. 1A and 6A, illumination light is reflected from the polarization separator to the reflective image display unit, and in the embodiment of FIG. 9A, illumination light is transmitted through the polarization separator and then is incident onto the reflective image display unit. However, the polarization separator of each embodiment can have a reverse optical path since the polarization separation function of the polarization separator is not affected even when illumination light travels along the optical path in a reverse direction.

Furthermore, although optical paths are defined with respect to the XY, YZ, and ZX planes in the previous embodiments, the optical paths can be differently defined without departing from the scope of the present invention by changing the positions of the polarization separation surface and the reflection surface.

In addition, although the polarization direction rotating member 4 is used for the polarization separator in the embodiment of FIG. 9A, a quarter wave plate having a main axis making an angle of 45° with the reference incident plane can be used instead of the polarization direction rotating member 4. In this case, unlike the embodiment of FIG. 6A, almost no optical loss occurs at the WGP 8 although a normal line to the reflection surface of the reflective image display unit 5 is not parallel with the reference incident plane when the reflective image display unit 5 is in on state.

In addition, although the wavelength of illumination light emitted from the light source unit is λ in the above-described embodiments, a plurality of light source units emitting red, green, and blue wavelengths of light can be used. In this case, polarization separators and reflective image display units may be disposed according to the wavelengths of the light, and an optical path combining unit, such as a dichroic prism combining wavelengths, can be used to combine optical paths before the light is projected to an optical projection unit. In this way, a color image projecting apparatus can be provided. Furthermore, when a polarization separator can be commonly used for each wavelength of the light, an optical path combining unit may be used to combine a plurality of optical paths into a single optical path, and a reflective image display unit may be commonly used for each wavelength of the light.

Moreover, the elements illustrated in each embodiment can be used in other ways within the scope of the present invention.

According to the image projecting apparatus of the present invention, the influence of an incident angle of light to the polarization separator, which causes an undesired change in the polarization direction of the light departing from the polarization separator, can be reduced or eliminated. Therefore, optical loss can be reduced at the polarization separator.

While the image projecting apparatus of the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image projecting apparatus comprising:
a polarization separator comprising a polarization separation surface which transmits or reflects illumination light and reflection light, reflected from a reflective image display unit according to polarization directions of the illumination light and the reflection light; and
a polarization direction rotating member, disposed between the polarization separator and the reflective image display unit, which rotates a polarization direction of light, which passes through the polarization direction rotating member on a path from the polarization separator to the reflective image display unit and again on a path from the reflective image display unit to the polarization separator, by 90° about an optical axis of the polarization separator,
wherein the polarization separator and the polarization direction rotating member are disposed such that an axis bisecting an angle between a principal ray of the illumination light passing through the polarization separation surface and incident onto the reflective image display unit and a principal ray of the reflection light reflected from the reflective image display unit is approximately consistent with the optical axis of the polarization separator.

2. The image projecting apparatus of claim 1, wherein the polarization separator comprises a polarization splitter comprising a dielectric multi-layer forming a polarization separation surface which separates S-polarized light and P-polarized light.

3. The image projecting apparatus of claim 1, further comprising a quarter wave plate disposed between the polarization separator and the polarization rotator, the quarter wave plate having a main axis in substantially the same direction as a polarization direction of light separated at the polarization separation surface and directed to the reflective image display unit.

4. The image projecting apparatus of claim 1, wherein the polarization direction rotating member is a quarter wave plate having a main axis in a plane perpendicular to the optical axis of the polarization separator, the main axis making an angle of about 45° with a polarization direction of light separated at the polarization separation surface toward the reflective image display unit.

5. The image projecting apparatus of claim 1, wherein the polarization separator comprises a wire grid polarizer (WGP) comprising a plurality of metal wires arranged on an insulator in parallel with each other at a minute pitch.

6. The image projecting apparatus of claim 5, wherein the metal wires have a length direction parallel with a middle plane that contains a normal line to a reflection surface of the reflective image display unit and bisects an angle between an incident plane of a principal ray of the illumination light incident onto the WGP and an incident plane of a principal ray of the reflection light reflected from the reflection surface and incident onto the WGP.

7. The image projecting apparatus of claim 5, wherein the metal wires have a length direction normal to a middle plane that contains a normal line to a reflection surface of the reflective image display unit and bisects an angle between an incident plane of a principal ray of the illumination light incident onto the WGP and an incident plane of a principal ray of the reflection light reflected from the reflection surface and incident onto the WGP.

8. The image projecting apparatus of claim 5, wherein the WGP and the reflective image display unit are disposed such that an optical path of a principal ray of the illumination light passing through the WGP and arriving at the reflective image display unit is shorter in length than an optical path of a principal ray of the reflection light reflected from the reflective image display unit and incident onto the WGP.

9. The image projecting apparatus of claim 5, wherein the polarization separator is a quarter wave plate having a main axis in a plane perpendicular to the optical axis of the polarization separator, the main axis making an angle of about 45° with a polarization direction of light separated at the polarization separation surface toward the reflective image display unit.
